(19) United States
(12) Patent Application Publication
(10) Pub. No.: US 2013/0161270 A1
(43) Pub. Date: Jun. 27, 2013

(54) SEWAGE SOLIDS SEPARATOR AND DEWATERING PLANT

(71) Applicant: Ken M. Stedman, Redondo Beach, CA (US)

(72) Inventor: Ken M. Stedman, Redondo Beach, CA (US)

(21) Appl. No.: 13/806,667

(22) PCT Filed: Jul. 2, 2011
(86) PCT No.: PCT/IB11/01547

§ 371 Date: Feb. 14, 2013

Related U.S. Application Data
(60) Provisional application No. 61/361,068, filed on Jul. 2, 2010.

(51) Int. Cl. B01D 33/00

(52) U.S. Cl. CPC B01D 33/0058
USPC 210/770; 210/297; 210/783

(57) ABSTRACT

A sewage solids separator and dewatering plant and method of use including a raw sewage inlet through which waste water enters the plant, and a baffle within the inlet for receiving and reducing kinetic energy, of the waste water. A curved ramp positioned below the baffle is enabled for directing the waste water to an inclined conveyor. The conveyor has a continuous belt enabled for passing water to a reservoir below the reservoir and for carrying solid matter to a top of the conveyor. The belt is stretched between an upper pulley and a lower pulley thereby establishing a linear path having a straight run of both an upper and the lower portions of the belt. A drag-out basin is positioned below the conveyor, and has an auger screw capable of removing the solid matter from the drag-out basin.

### BACKGROUND

This disclosure relates generally to plants for extracting solid materials from aqueous solutions and more specifically for separating out waste solids from raw sewage.

### DESCRIPTION OF RELATED ART INCLUDING INFORMATION DISCLOSED UNDER 37 CFR 1.97 AND 1.98

U.S. Pat. No. 165,826 discloses a device that uses air blow from the underside of the filtering band to lift water and particles from the band and direct the water back to the band. This device is not capable of giving any satisfactory operation in cleaning plants of interest herein, i.e., cleaning of municipal waste water.

WO A87/02595 (Ericksson) describes blowing pressurized air or water from above towards a filtering belt and collecting the residue in a collecting chute. This form of residue removal has not been effective. Air blowing in this way is at best suitable for removal of dry filtrate not containing fat or similar compounds.

U.S. Pat. No. 4,921,608 solves this problem by spraying hot water vapor. However, this technical solution is both equipment and energy demanding and it is for that reason an efficient but costly implementation.

U.S. Pat. No. 178,608 describes a plant having an endless filtering belt carried through a waste water container for filtering of waste water, wherein the filtering band is carried over numerous rollers in such a way that in a certain area it runs substantially horizontally with the residue turned downwards. Within this area there is a rod shaped exhaust or blow off device to effect an air blow towards the filtering belt. A blow off device is arranged in parallel with the blow off device and downstream to spray water jets towards the filtering band. This plant has several weaknesses with regard to the cooperation between its separate modules. An example of the latter is causing the blow off device, which has a particularly high energy demands to achieve satisfactory tearing-off effect.

U.S. Pat. No. 6,942,786 discloses a plant for cleaning waste water. The plant includes a waste water container for receiving a flowing supply of waste water; and an endless filtering belt guided through the container for filtering the waste water, the belt passing over a series of turn rollers that define an upward rising section and a horizontal section wherein residue trapped on the belt faces downward. The plant also has a controller for controlling the speed of the filtering belt relative to the supply of waste water to maintain the waste water surface below a selected level and thus obtain a strong dewatering effect within the upward rising section of the filtering belt. A blow off device is mounted over the horizontal section of the filtering belt for blowing air at the filtering belt. The blow off device has an elongated slit with a section expanding from a constriction, and a curved transition region leading from the expanding section to a front end side of the blow off device. A nozzle pipe is used for spraying water jets toward the filtering belt, the nozzle pipe being mounted in parallel with the blow off device and downstream from it. An auger screw conveyor is arranged below the blow off device for dragging out the residue dislodged from the filtering belt.

The related art described above discloses several solutions to the problem described above and to which the present invention is directed. However, the prior art fails to disclose an efficient plant that is free from the problems of jamming and requiring constant maintenance. The present disclosure distinguishes over the prior art providing heretofore unknown advantages as described in the following summary.

### OBJECTIVES

This disclosure teaches certain benefits in construction and use which give rise to the following objectives.

The general objective of the invention is to increase plant throughput and efficiency.

A particular objective is to prevent contamination of a lower portion of the conveyor filter belt by drainage from the upper portion of the conveyer filter belt.

A further objective is to reduce operating power by eliminating the need for the prior art air blower and air knife.

A still further objective is to prevent direct impingement of influent onto conveyer.

A still further objective is to provide a longer path for gravity drainage without requiring a larger equipment footprint.

A still further objective is to improve water throughput on the conveyor by using high pressure water spray.

A still further objective is to improve solids removal from the conveyer by using plural scrapers.

A still further objective is to provide an auger screw press for improved dewatering of removed solids.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE DRAWINGS

Illustrated in the accompanying drawing(s) is at least one of the best mode embodiments of the present invention In such drawing(s):

FIG. 1 is a side elevational view of a prior art conveyor separator;

FIG. 2 is a cutaway side perspective view of the present invention as viewed from the inlet side of the machine;

FIG. 3 is a cutaway further perspective view thereof as viewed from a frontal side;

FIG. 4 is a side elevation cutaway view thereof;

FIG. 5 is a sectional view of a conveyor of the invention as seen along cutting line 5-5 in FIG. 2 and showing a first embodiment of a liquid diverting plate; and

FIG. 6 is the same sectional view as in FIG. 5 showing a further embodiment of the liquid diverting plate.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the presently described apparatus nor its method of use.

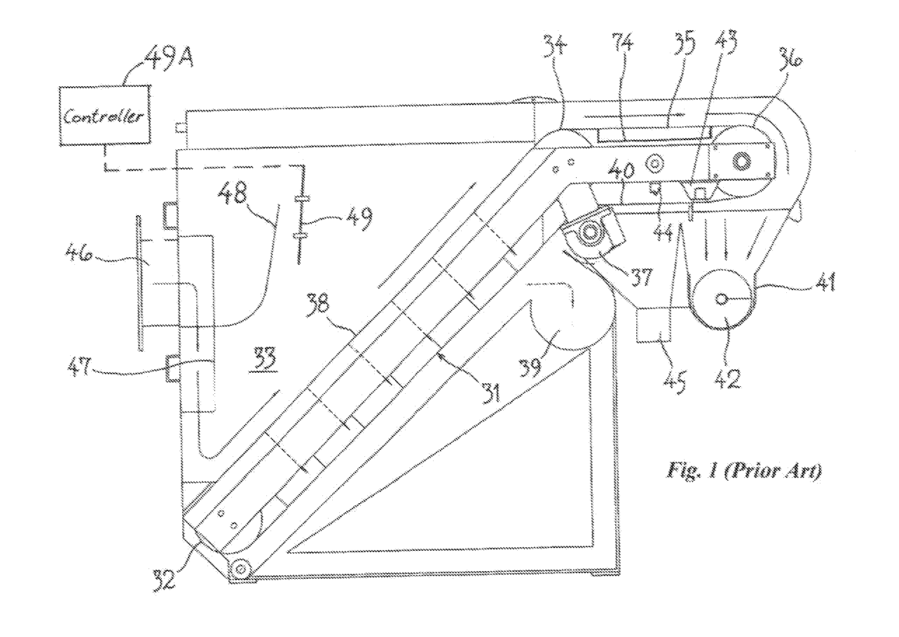

U.S. Pat. No. 6,942,786, (see FIG. 1) teaches a separator plant similar to the present invention described below including certain details in construction and operation that are similar to the invention. Therefore, U.S. Pat. No. 6,942,786 is hereby incorporated herein by reference in its entirety.

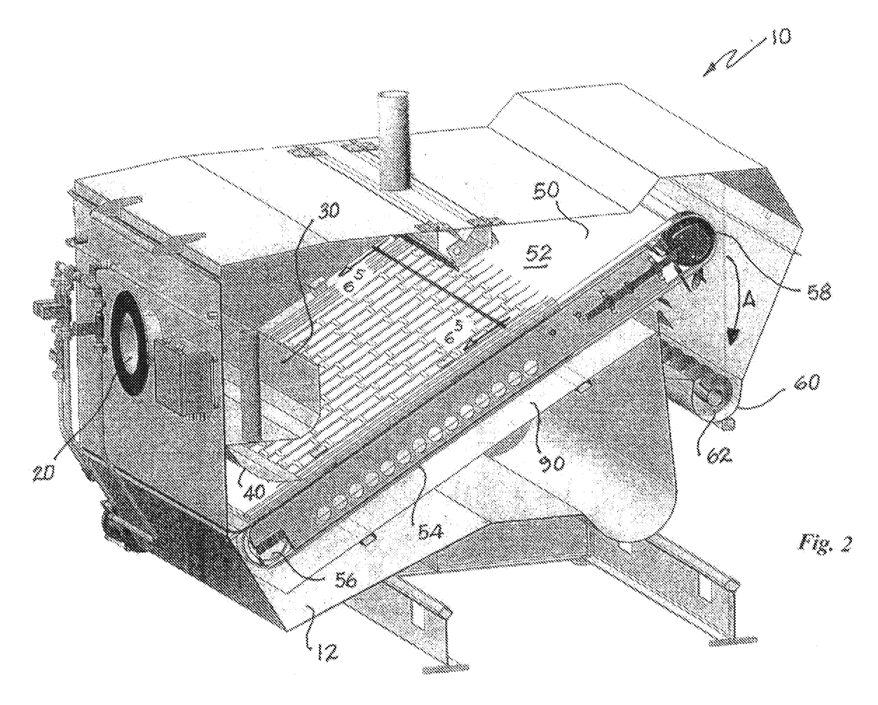

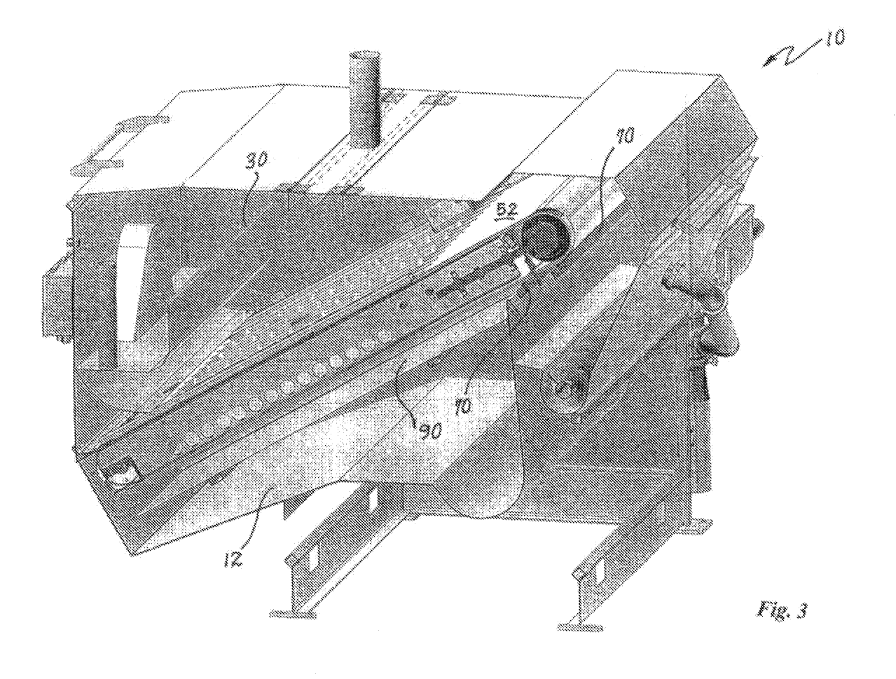

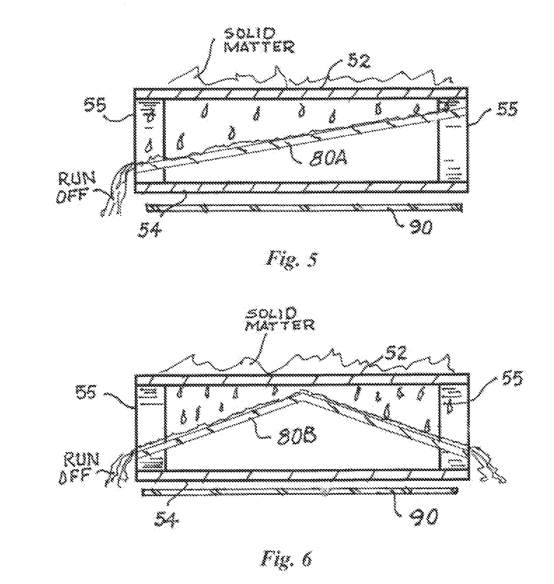

The present invention is a sewage solids separator and dewatering plant 10 as shown in FIGS. 2-6. A raw sewage inlet 20 is shown in FIG. 2 through which waste water enters the plant 10. Upon entry, the waste water moves against a baffle 30 which reduces its kinetic energy, and is then free to fall onto a curved ramp 40 which directs the waste water onto an upper belt portion 52 of a conveyor 50 that travels upward along an inclined path on rollers 55 (FIGS. 5 and 6). The conveyor belt is made of a filter fabric which has the properties of allowing water to pass through while capturing solid matter on and within its surface. Water passes through the upper belt portion 52 and falls downward therefrom eventually filling a reservoir 12 of the plant 10. The solid matter is carried on the upper belt portion 52 upwardly while dripping water as the belt moves upwardly. At the top of the conveyor 50, the belt makes a 180° turn and travels downwardly, as a lower belt portion 54 along a path that is preferably parallel to the upper belt portion 52. The belt is continuous and mounted, e.g., stretched, between a lower idler pulley 56 that does not have sprockets, and an upper sprocketed drive pulley 58. Because the conveyor's belt is stretched between only its lower pulley 56 and its upper pulley 58, it extends between these pulleys in straight runs of both the upper 52 and the lower 54 belt portions. As the upper belt portion 52 makes the 180° turn, solid matter falls into a drag-out basin 60 as shown by arrow “A” in FIG. 2. Solid matter that tends to adhere to the belt as it moves around the upper pulley 58 is dislodged by two wipers 70 which are positioned as shown in FIG. 3 so as to press against and scrape the belt.

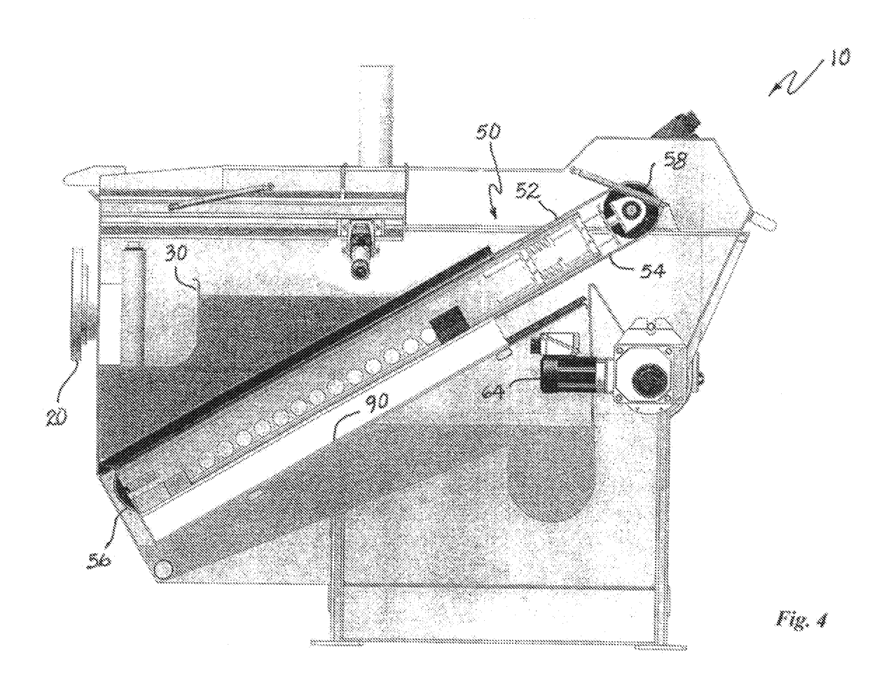

An auger screw conveyor 62 is positioned in the drag-out basin 60 for removing the solid matter from the plant as is best seen in FIGS. 2 and 3. The auger screw conveyor 62 is driven by motor 64 shown in FIG. 4.

Located between the upper 52 and lower 54 belt portions of the conveyor belt is a rigid baffle 80A or 80B (FIGS. 5 and 6) which has a surface for draining water falling from the upper belt portion 52 so that it doesn't fall onto the lower belt portion 54. Clearly, the water flowing through the upper belt portion 52 carries particles of the solid matter which would tend to enter the lower belt portion 54 as it falls downwardly from the upper belt portion 52. This is undesirable as it would tend to foul the lower belt portion 54. Therefore, to avoid contamination falling from the upper belt portion 52, the rigid baffle 80A or 80B deflects it to one side, or to both sides. This surface of the rigid baffle 80A or 80B has the same incline as the conveyor 50 and extends between the upper 58 and the lower 56 pulleys. It also has a lateral pitch from one side of the conveyor 50 to the other side. In one embodiment shown in FIG. 5, the surface of the rigid baffle 80A is closer to the upper belt portion 52 on one side (right side in FIG. 5) of the conveyor 50 and closer to the lower belt portion 54 on the other side (left side in FIG. 5) of the conveyor 50 so that water on the rigid baffle surface moves downwardly and also laterally to fall as run off into the reservoir 12 as shown.

In another embodiment shown in FIG. 6, the rigid baffle surface is crowned at its center so that it is closer to the upper belt portion 52 along the center of the conveyor 50 and closer to the lower belt portion 54 on both lateral sides of the conveyer 50, so that the water on the rigid baffle surface moves downwardly and laterally to both sides of the conveyer 50 as shown. In either of these embodiments, the water dripping from the upper belt portion is intercepted by the rigid baffle 80A or 80B and delivered to the reservoir 12 without fouling the lower belt portion 54.

As shown in FIGS. 2-6 a further baffle 90 is mounted below conveyor 50 and extensive between pulleys 56 and 58. Baffle 90 receives any solid or semi-solid materials which may fall off the lower belt portion 54 of conveyor 50. Baffle 90 also is positioned for preventing splashes from reservoir 12 from reaching the lower belt portion 54 which would tend to fowl the conveyor 50.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

While the invention has been described with reference to at least one preferred embodiment, it is to be clearly understood by those skilled in the art that the invention is not limited thereto.

1. A sewage solids separator and dewatering plant comprising:
a raw sewage inlet through which waste water enters the plant;
a baffle within the inlet, the baffle positioned to receive, and reduce kinetic energy, of the waste water;
a curved ramp positioned below the baffle and enabled for directing the waste water to an inclined conveyor;
the conveyor having a continuous belt enabled for passing water therethrough to a reservoir and further enabled for carrying solid matter to a top of the conveyor;
the belt stretched between an upper pulley and a lower pulley thereby describing a linear path having a straight run of both an upper and a lower portions of the belt;
a drag-out basin positioned below the conveyor, the having an auger screw adapted and positioned for removing solid matter from the drag-out basin.

2. The sewage solids separator and dewatering plant of claim 1 wherein the belt is made of a filter fabric allowing water to pass through while capturing solid matter thereon.

3. The sewage solids separator and dewatering plant of claim 1 further comprising a inclined rigid baffle having a surface positioned for receiving water falling from the upper belt portion and preventing said falling water from reaching the lower belt portion.

4. The sewage solids separator and dewatering plant of claim 3 wherein the surface of the rigid baffle is close to the upper belt portion on one side and close to the lower belt portion on the other side of the conveyor so that water on the rigid baffle surface moves laterally to one side of the conveyor.

5. The sewage solids separator and dewatering plant of claim 3 wherein the surface of the rigid baffle is peaked so that water on the rigid baffle surface moves laterally to both sides of the conveyor.

6. The sewage solids separator and dewatering plant of claim 3 further comprising a further baffle mounted below the conveyor and extensive between the pulleys so as to receive any solid or semi-solid materials which may fall off the lower belt portion.

7. A method of separating sewage into solids and liquids using a dewatering plant comprising:
delivering a raw sewage into an inlet of the plant;
receiving and reducing the kinetic energy, of the waste water against a baffle;
directing the waste water off a curved ramp positioned below the baffle to an inclined conveyor;
moving a continuous belt of the conveyor while draining liquid from the waste water through the belt and allowing a solids portion of the waste water to move upwardly to a top of the conveyor;
stretching the belt between an upper pulley and a lower pulley thereby describing a linear path having a straight run of both an upper and a lower portions of the belt;
positioning a drag-out basin below the conveyor for catching matter dropping off the top of the conveyor;
removing solid matter from the drag-out basin using an auger screw.

8. The method of separating sewage of claim 7 further comprising fabricating the belt of a filter fabric and allowing water to pass through the belt while capturing solid matter thereon.

9. The method of separating sewage of clam 7 further comprising positioning an inclined rigid baffle in a position for receiving water falling from the upper belt portion and preventing said falling water from reaching the lower belt portion.

10. The method of separating sewage of claim 7 further comprising positioning a surface of the rigid baffle close to the upper belt portion on one side of the conveyor, and close to the lower belt portion on the other side of the conveyor there by moving water on the rigid baffle to drain from one side of the conveyor.

11. The method of separating sewage of claim 10 further comprising positioning a peak of the surface of the rigid baffle medially under the upper portion of the belt thereby moving water on the rigid baffle to drain from both sides of the conveyor.

12. The method of separating sewage of claim 10 further comprising positioning a further baffle below the conveyor and extending it between the pulleys thereby receiving any solid or semi-solid materials which may fall off the lower belt portion.

13. A method of separating sewage into solids and liquids using a dewatering plant comprising:
directing the waste water to an inclined conveyor ;
moving a continuous belt of the conveyor while draining liquid from the waste water through the belt and allowing a solids portion of the waste water to move upwardly to a top of the conveyor;
stretching the belt between two pullies thereby describing a linear path having a straight run a bottom and the top of the belt;
positioning a drag-out basin below the conveyor for catching matter dropping off the top of the conveyor.

14. The method of separating sewage of clam 13 further comprising positioning an inclined rigid baffle in a position for receiving water falling from an upper belt portion and preventing said falling water from reaching a lower belt portion.

15. The method of separating sewage of claim 13 further comprising positioning a further baffle below the conveyor and extending it as necessary to receive solid or semi-solid materials which may fall off the conveyor.
